(19) United States
(12) Patent Application Publication
(10) Pub. No.: US 2014/0026128 A1
(43) Pub. Date: Jan. 23, 2014

(54) Educational Management System and Method of Operation for Same

(71) Applicant: OpenPeak Inc., Boca Raton, FL (US)

(72) Inventors: Alexander Rocha De la hoz, Boynton Beach, FL (US); Narendra Narayana, Boynton Beach, FL (US)

(21) Appl. No.: 13/737,860

(22) Filed: Jan. 9, 2013

Related U.S. Application Data
(60) Provisional application No. 61/584,734, filed on Jan. 9, 2012.

(51) Int. Cl. G06F 21/44; G06F 9/445; G06F 17/21

(52) U.S. Cl. CPC G06F 21/44; G06F 17/212; G06F 8/65
USPC 717/168; 726/29; 715/202

(57) ABSTRACT

A method of selectively deactivating features on a computing device is described herein. The method can include the step of determining an examination time period for one or more students in which each of the students is in possession of a computing device. The examination time period can be set aside to enable the students to participate in a testing exercise. The method can further include the steps of generating a deactivation signal and transmitting the deactivation signal. The deactivation signal, when received at the student computing devices, can cause the student computing devices to selectively deactivate predetermined features of the student computing devices. The predetermined features may be based on a factor of providing an unfair advantage to a student during the examination time period.

### CROSS-REFERENCE TO RELATED APPLICATIONS

This application claims the benefit of U.S. Provisional Patent Application No. 61/584,734, filed on Jan. 9, 2012, which is incorporated herein by reference in its entirety.

### TECHNICAL FIELD

The present invention relates to systems and methods for managing offering services to networked devices.

### BACKGROUND

The use of applications, commonly referred to as “apps,” has become prevalent over the past few years. To meet this demand, several entities have developed services to enable users of mobile devices to download apps to such devices. For example, Apple, Inc. of Cupertino, Calif. offers an interface to permit apps to be uploaded from app developers and for users to search, select and possibly purchase apps for download to Apple devices. As part of this process, the company offers a software development kit (SDK) to developers for guidance on creating these apps, and the apps must be approved by Apple before being made available to users. In addition, Apple shares with the app developers the revenue that is generated by the downloads. Other companies, such as Google, Inc. of Mountain View, Calif. and Research In Motion, Ltd., of Waterloo, Ontario, Canada, also offer interfaces for developers to create and upload apps and for users to retrieve such software.

Thus, there are multiple companies that offer this service, and it is expected that the number of them doing so will increase. While this recent development has established a new platform for the delivery of software to a wide variety of mobile devices, general oversight of this process is lacking. This aspect can be particularly troublesome in an enterprise setting. For example, a company may be leery of allowing employees to access and download apps from these services onto its work devices because the employer has no control over the process. A similar concern exists in a personal or family environment because a parent will not have any control over his/her child's activities in this area. In fact, supervisory authorities, like employers and parents, have very little control over mobile devices that are distributed to their subordinates.

Additionally, as smartphones have evolved over the years, consumers have become increasingly reliant on these devices, particularly when it comes to managing their personal affairs. Many enterprises, however, have resisted putting corporate data on the personal devices of their employees due to potential security breaches. For example, many applications (or “apps) installed on personal devices contain malware or some other questionable code. Currently, information technology (IT) departments have no way of managing the personal devices of their employees. As a result, sensitive enterprise data, if installed on an employee's personal device, may be subject to attack from a dishonest source. This potential security breach has led many companies to resist integrating corporate apps and information in the operating environment of a worker's personal mobile device.

### SUMMARY

A method of selectively deactivating features on a computing device is described herein. The method can include the step of determining an examination time period for one or more students, each in possession of a computing device, in which the examination time period is set aside to enable the students to participate in a testing exercise. The method can further include the steps of generating a deactivation signal and transmitting the deactivation signal. The deactivation signal, when received at the student computing devices, can cause the student computing devices to selectively deactivate predetermined features of the student computing devices. The predetermined features are based on a factor of providing an unfair advantage to a student during the examination time period. For example, if a feature—such as an application—would permit a student to have access to information that would give the student an unfair advantage, that feature could be effectively shut down during the examination time period. Once the examination time period is complete, the deactivated features can be reactivated.

This process may be selective in nature in that only certain features may be deactivated, depending on the choice of the testing authority. For example, students may be granted access to applications that can access information from different resources for certain examinations but not for others. In another example, the students may be granted access to applications that can access information, but the texting or messaging feature of the computing devices of the students may be deactivated to prevent the students from unfairly sharing information.

In one arrangement, the predetermined features of the student computing devices that are deactivated can include applications, access to communications networks and calculators. For example, any relevant communication stacks of the student computing devices may be shut down to limit cheating. In another arrangement, the deactivation signal can be generated by a computing device of an examination proctor, such as a teacher.

The method can also include the step of forcing the student computing devices into a testing mode in which the deactivation of the predetermined features is part of the testing mode. As another example, another part of the testing mode can be automatically silencing the student computing devices to prevent the broadcast of ring tones during the examination time period.

A system for selectively deactivating features on a computing device is described herein. The system can include a transceiver that is configured to communicate with one or more computing devices associated with one or more students. The system can also include a processor that can be communicatively coupled to the transceiver. In one arrangement, the processor can be configured to determine an examination time period for the students, each in possession of a computing device, in which the examination time period is set aside to enable the students to participate in a testing exercise. The processor can also generate a deactivation signal in response to this determination, and the transmitter can transmit the deactivation signal. The deactivation signal, when received at the student computing devices, can cause the student computing devices to selectively deactivate predetermined features of the student computing devices. The predetermined features are based on a factor of providing an unfair advantage to a student during the examination time period.

A method of preparing a learning package for a group of students is also described herein. The method can include the step of retrieving the learning package from a database, and the learning package can include predetermined materials that are designed to enable the students to learn a topic. For example, a school district or some other organization may prepare learning packages for a wide variety of educational topics, including those for particular lessons of such a topic. These learning packages may or may not be uniform across the district or some other jurisdiction, like a state or a country. The method can further include the step of selecting all or a portion of the materials from the learning package and publishing the selected materials to computing devices that are associated with the students. This process can provide an assignment to the students to complete at least a portion of the selected materials.

As an example, the predetermined materials can include reading materials, videos, on-line resources or examinations. As another example, the database can be associated with an electronic storefront. The electronic storefront may be associated with a school district such that the school district determines which materials are to be included in the learning packages and which learning packages are to be offered at the electronic storefront. In this case, the electronic storefront may be developed and maintained by or on behalf of the school district.

The method can further include the step of reporting the progress of the students in relation to the completion of the assignment. The reporting of the progress of the students may be in terms of the overall completion of the assignment or in terms of the individual components of the assignment. For example, if a student has completed 50% of an assignment or 50% of a component of an assignment that has several components, then that progress can be reported. The progress can be reported back to the computing device of the teacher or other individual who assigned the assignment. In one arrangement, the reporting of the progress of the students is done through a progress indicator assigned to each of the students. The progress indicator can be a visual element that is displayed on the computing device of the teacher or the person who assigned the assignment. As another example, the reporting of the progress of the students may also provide an indication as to the accuracy of the work of the students for the assignment.

A system for preparing a learning package for a group of students is also described herein. The system can include a database that can be configured to store a learning package that can have predetermined materials that are designed to enable the students to learn a topic. The system can also include a processor that is communicatively coupled to the database. The processor can be configured to retrieve the learning package from a database and to select all or a portion of the materials from the learning package and to cause the selected materials to be published at the computing devices that are associated with the students. This process can provide an assignment to the students to complete at least a portion of the selected materials.

A method of modifying an application is also described herein. This method can include the steps of receiving a non-educational application in its original form and injecting an educational aspect into the non-educational application, thereby creating a modified application. This injection can occur when the non-educational application undergoes a wrapping process. When the modified application is launched, the educational aspect may interrupt the original flow of the application to direct a user to complete an educational task before the original flow can be resumed. In one arrangement, the educational task is one or more questions related to a certain topic, and the original flow is resumed if the user provides correct answers or at least attempts to provide correct answers.

Consider the following example. A non-educational application, such as a gaming application, can be obtained and subjected to the wrapping process in which new functionality can be injected into the application. When the modified application is launched, a user may be asked to provide information related to certain educational topics at particular points of operation of the application. For example, at launch, a user may be asked to solve a word problem or to enter the answer for a mathematical problem. If the user provides the correct answer or at least attempts to answer, the application can be launched. Additional questions may be presented during the operation of the application, such as when a user reaches a particular stage in the application. In one arrangement, the modified application may be intended to be part of an educational profile for a computing device of a student.

A system for modifying an application is also described herein. The system can include a transceiver configured to receive a non-educational application in its original form. The system can also include a processor, which can be communicatively coupled to the transceiver. The processor can be configured to injecting an educational aspect into the non-educational application, thereby creating a modified application. When the modified application is launched, the educational aspect may interrupt the original flow of the application to direct a user to complete an educational task before the original flow can be resumed.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate portions of the present invention and, together with the description, further serve to explain at least some of the principles of the invention and to enable a person skilled in the relevant art(s) to make and use the invention.

FIG. 1 illustrates an example of a system for educational management.

FIG. 2 illustrates an example of an assignments page.

FIG. 3 illustrates an example of a progress page.

Applicants expressly disclaim any rights to any third-party trademarks or copyrighted images included in the figures. Such marks and images have been included for illustrative purposes only and constitute the sole property of their respective owners.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

The following detailed description refers to the accompanying drawings that illustrate exemplary embodiments; however, the scope of the present claims is not limited to these embodiments. Thus, embodiments beyond those shown in the accompanying drawings, such as modified versions of the illustrated embodiments, may nevertheless be encompassed by the present claims.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the art to implement such feature, structure, or characteristic in connection with other embodiments whether or not explicitly described.

Several definitions that apply throughout this document will now be presented. The term “exemplary” as used herein is defined as an example or an instance of an object, apparatus, system, entity, composition, method, step or process. The term “communicatively coupled” is defined as a state in which two or more components are connected such that communication signals are able to be exchanged between the components on a unidirectional or bidirectional manner, either wirelessly, through a wired connection or a combination of both. A “computing device” is defined as a component or a group of components that are configured to process and/or present data to a user or another component or group of components. A “user interface element” is defined as a component or a group of components that enables a user to interact with a machine. The term “graphical user interface element” is defined as an image or a portion of an image that presents information to a user or allows the user to interact with a device through a display. An “interface” is defined as a component, system or arrangement or groups thereof that enable information/data to be entered into a machine.

A “display” is defined as a component or a group of components that present information/data in visual form. A “processor” is defined as a component or a group of components that at least execute instructions. A “transceiver” is defined as a component or a group of components that transmit signals, receive signals or transmit and receive signals, whether wirelessly or through a hard-wired connection. The term “examination time period” is defined as a time interval designated for an examination or evaluation process.

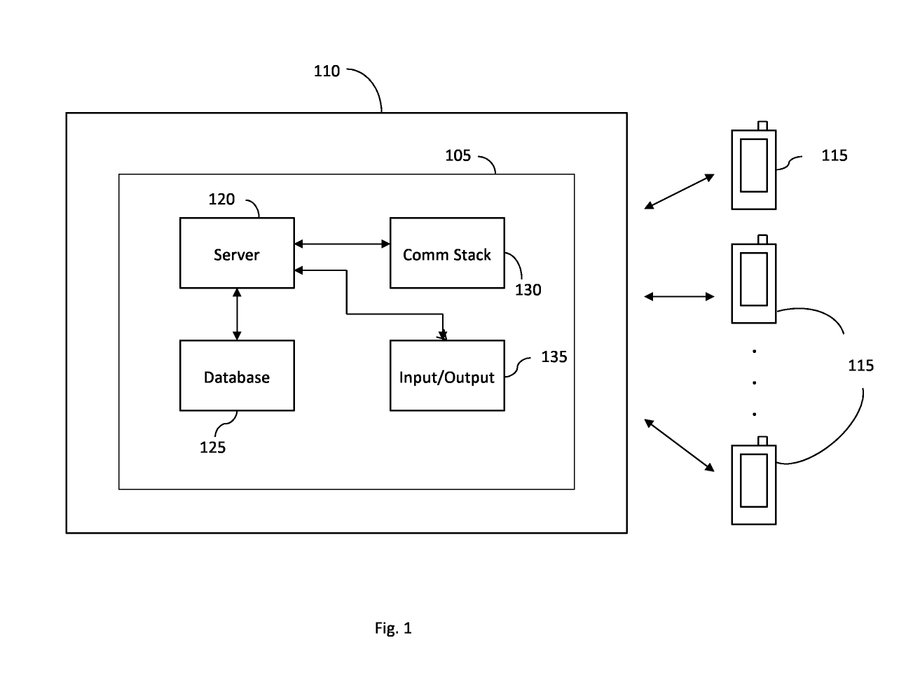

Referring to FIG. 1, an example of a system 100 for educational management is shown. In one arrangement, the system can include an operational center 105, which can be positioned at, for example, an educational facility 110 or some other suitable location. The operational center 105 can communicate with any number of computing devices 115, either issued by an organization, such as a school district, or personally owned by individuals, such as those associated with the school district, like students, teachers, etc. In one arrangement, the operational center 105 can include a server 120, one or more databases 125, one or more communication stacks 130 and one or more input/output devices 135. The databases 125 may be part of the server 120 or may be components that are physically separate from the server 120. In either arrangement, the databases 125 may include information related to organizational policies and individuals associated with the organization. For example, a school district may store information related to policies that it sets, which may be applied to the management of the computing devices 115 and applications installed on those devices 115. As another example, the school district may store content—such as in the form of bundles—that may be designated for delivery to a particular computing device 115. In addition, information related to users of the computing devices 115, like teachers and students, may be stored in the databases 125. The communication stacks 130 may be configured to communicate with the computing devices 115 through any suitable means, including wireless or wired connections, either solely or in combination with one another. The wireless connections may be through cellular or other wireless standards, like Wi-Fi.

There have been significant growth and technological advances in the areas of mobile device management and securitization of such devices. Many of these concepts are presented in several patent applications, including U.S. Patent Application Publication No. 2012/0036552, filed on Jul. 9, 2011 and U.S. patent application Ser. No. 13/626,470, filed on Sep. 25, 2012, each of which is incorporated by reference herein in its entirety. The systems and processes described in these applications can be implemented into numerous platforms and settings. For example, these systems and processes may be useful in an educational setting. In particular, a school district or other educational agency may wish to provide managed mobile devices or other managed computing devices to its teachers, administrators, support personnel, students and even the parents of students. This management scheme may also be applied to the personal computing devices of such individuals, which may be provisioned to enable an entity to manage at least some aspects of those devices.

Consider the following illustrative (i.e., non-limiting) scenario. A school district may provide computing devices to its teachers, students and administrators, including necessary support personnel. The school district may cooperate with a computing device provider or some other entity to establish the type of settings and content that may apply to these devices, which can be mobile devices. As described earlier, the settings and content can be delivered to the computing devices once the computing devices have been provided to the relevant parties (e.g., the students and teachers). This can increase the flexibility of the computing devices that are delivered to the school board because they can be populated with content/settings once the appropriate receiving parties have been identified.

As another example, the school district may provision the personal computing devices owned by students, teachers, other district personnel and parents to enable management of at least some of the features of these devices. For example, a personal device of a student may be configured with both personal and educational spaces. The personal space may include settings, applications, content and information related to the student's personal life. In contrast, the educational space may include settings, applications, content and information related to the student's academics. In addition, applications intended for the educational space may be modified and managed, if so desired. Examples of this process will be presented below.

In one arrangement, bundles can be generated for certain groups of teachers or students, including for computing devices issued by the school district (or other entity) or personal computing devices owned by the teachers or students. For example, the school board or some other suitable entity can determine which applications, settings and other content are to be part of the bundles to be delivered to the recipients. As a more specific example, bundles can be generated for each grade level of a school system, such as a third grade bundle being put together for students who are in the third grade. Likewise, bundles can be prepared that target groups of teachers who teach related or similar subjects. For example, a bundle can be developed for math teachers, while another can be generated for teachers who teach civics courses.

These bundles can include applications and other content that are appropriate for the intended recipients (or groups of recipients). This process can be useful and efficient because the school board can select a default set of material that is to be provided to its employees and students based on, for example, their functions and grade levels. The bundles, as noted earlier, can include settings that can be applied to the computing devices of the employees and students. For example, the bundles intended for younger grade levels can—when installed—disable an Internet browser on the mobile devices of these students. The browser, however, can be enabled for older students.

The applications that can be part of a bundle can undergo an approval process. For example, app developers can submit their applications to an app developer portal, and the application can be tested and approved at an approval portal. Once approved these application can be made available for selection in a bundle or for individual delivery to a computing device.

In another arrangement, at least some of the applications that are to be included as part of a bundle may be modified to enable the application to be managed. For example, as is known in the art, these applications may have new functionality injected into them through a process referred to as application wrapping. This process can enable, for example, the school district to place restrictions on the operation of certain applications or to enable an application to achieve new functionality.

For example, a gaming application may be included as part of a bundle for one or more students, one that may be offered at an electronic storefront and that may improve some learning skill. While helpful, operation of the gaming application during school hours may be disruptive to a learning environment. As such, this application may undergo the wrapping process to prevent it from launching during school hours or while on school grounds. As another example, a conventional application from an electronic storefront may be wrapped to add or integrate an educational feature into its normal operation. As a specific example, a gaming application may present mathematical equations or reading comprehension questions, which must be answered to permit the student to proceed with the launching or continued operation of the application.

Once a student, teacher or any other suitable party receives a computing device or has their own personal device provisioned, the party can log in on the device with the proper credentials. This process can cause the computing device to be associated with, for example, a specific student or teacher, and the appropriate bundles and any other suitable content, settings or parameters can be delivered to the computing device.

The initial bundles (or other content/settings) that were delivered can be updated, including during the school year. As another example, the bundles can be updated when the student enters a new grade level. Individual applications or other content can also be pushed to or removed from relevant computing devices. Firmware packages, including updates, can also be delivered to the computing devices.

In one example, applications that are available for deployment to a computing device can be designated with feedback from users of the application. In this case, applications that have been deployed by other school districts can include ratings and other relevant feedback criteria from students and teachers who have used the application. This material can include written comments or even multimedia content, so long as it provides some feedback on the application. This information can be helpful to a school district in deciding whether to distribute to its students or teachers an application that has been used by, for example, another school district.

In one embodiment, the school district described here may have an electronic application store or shop developed for its use. For example, the applications that have been approved can be published in the application shop, including applications that have been wrapped, as previously described. Of course, the school district still has the option of blocking certain approved applications from publication in the application shop. The school district can permit its employees or students to access the application shop and download approved applications. As an example, these applications can be segregated based on appropriateness for a particular age level or categorized based on the curriculum to which they relate. The students (or teachers) can be granted access to applications that are appropriate for their age or the classes that they are attending (or teaching). That is, an administrator may have the capability to specify a group of students or class levels that have permission to use an application or other content. Moreover, the school district can also enable or disable any application that is published in the application shop or even any application that has already been downloaded to a computing device. In fact, the school district can control and schedule how much time and when an application or other content can be used by a student or district employee. For example, applications may be managed and controlled in accordance with the policies of the school district, including restricting the operation of certain applications during school hours or while on school property.

It must be noted that the content provided by the application shop can also include materials such as videos, electronic books or interactive games. This content may be educational in nature but not necessarily so. This content can also undergo the same approval process as a conventional application before being published on the application shop and can be subject to the same controls described above in relation to the management of applications.

The application shop also provides an opportunity for a school district or some other party under the direction of the school district to build its own applications specifically targeted to its students or employees. A software development kit (SDK) may also be provided to the school district or the third party for this purpose. In addition, the application shop can support free, single, bulk, floating and time-of-use licenses for the applications. School district employees, parents and (possibly) students may purchase applications or other contents through any suitable payment mechanism.

Many management and service features can apply to the computing devices of the teachers, students and other personnel. In particular, an employee of the school district or an entity under the direction of the school district can remotely control the computing devices held by its employees and students. For example, a computing device can be locked or otherwise disabled or data on the device can be wiped or access to the data can be blocked. In addition, certain applications or other content, including URLs, can be blacklisted or whitelisted. Other examples include the following: (1) ability to provision, update, redeploy or decommission a student or teacher's computing device; (2) set device policies; (3) set restrictions on user names, passwords or PINs; (4) remotely manage e-mail configuration; and (5) control access to hardware elements, such as communication stacks, cameras, microphones, SD cards or GPS.

School district officials may also be given the ability to monitor certain aspects of the computing devices, such as device location, system resource availability (e.g., available memory and CPU capacity), determine active processes in the computing device and query a device's hardware and system state, like SIM operator, Wi-Fi-status, connected SSID, Bluetooth status, signal strength and battery life. Other services may include the ability to view user management (LDAP/AD) information and school district directory services information. Policies, certificates and other settings of the computing devices may also be under the control of the school district.

As mentioned earlier, individual applications on the computing devices may also be managed. For example, the operation of certain applications may be limited to hours outside of normal school hours or to locations outside of school grounds. As another example, information related to a particular application may be wiped or removed from a user's computing device. In addition, the management of applications may be carried out on an individual or group basis. For example, the management of a particular application may only be directed at a certain grade level in the school district, such as restricting its operation only for grades K-3 in the district. It must be stressed that the foregoing examples are not intended to be limiting. In fact, all the management features and services that were described earlier are applicable in this academic setting, and a school district or other organization is free to determine which ones are suitable for their deployment.

The ability to monitor and report business intelligence or analytics may apply in this setting, as well. For example, usage data can be monitored and recorded, which can enable school district employees to determine which applications or content are popular with, for example, teachers and students. Additional examples of analytics and reporting include the following: (1) tracking when and how much time an application is used, including cumulative or individual metrics for both applications and users; (2) ratings and other feedback for applications that is provided by students and teachers; (3) the installation history of applications; (4) total active device sessions and sessions per device; (5) browser history, bookmarks, cache and communications; (6) error reporting, including crash logs for applications; and (7) update histories, which may include date/time stamping. Any revenue associated with an application or other content may also be monitored and provided to, for example, application developers or other interested parties. It is understood that there are numerous other types of data and events that can be monitored and analyzed in addition to the examples provided here.

As pointed out earlier, students, teachers and other district personnel can be provided with computing devices, which can be managed by the school district. While these computing devices may be supplied by the school district, personal computing devices owned by these individuals can also be managed and serviced in accordance with the description herein. In either event, several examples of student, teacher and parent interaction with a computing device will be provided here.

Once a computing device is provisioned for a student, the student can receive messages that are relevant to the student's participation at the school. These messages can be broadcast messages that are intended for all or a group of students, such as the announcement of a school function or schedule, or can be designated for the individual student, like a notice to visit a counselor's office at some time in the future. Moreover, the student can receive assignments and other educational materials on the computing device. That is, the teacher or some other district employee can push educational materials to the student, and the student can access these materials through the computing device. It is important to note that this material may be limited to the educational work space of the computing device. Thus, the process of sending educational materials to the device may avoid any interference with the student's personal space or configurations set by the student. Continuing with the example, a teacher can cause a test to be pushed to the computing devices of the students in her class, and the students can receive notification of this examination through their devices. The student can access the test through the device, and once it's launched, a timer can be started to begin a countdown for the testing time.

In addition, the computing device can be configured to shut down or deactivate many other features or processes of the computing device to ensure that the student is not disturbed during the time for taking the test. For example, the computing device can deactivate portions of any suitable communications stacks to prevent incoming messages from interrupting the student. As another example, the applications and other content stored on the computing device can be disabled to minimize disruption, which can provide an additional benefit of preventing a student from cheating by accessing materials on the device that may be helpful in taking the test. This disablement can also be selective in nature, such as if the teacher wishes to allow access to certain applications during the test time, like during an “open book” examination. In another arrangement, when an application is wrapped, a deactivation feature may be integrated into the application that causes it to shut down or not launch when a signal is received from the framework of the educational work space. Thus, a teacher could, for example, block one or more applications during a test if those applications could be used to provide information that would give the students an unfair advantage on the test. Once the time for taking the test is over or the test is completed, full functionality may be returned to the device and/or the applications or other content.

To carry out this process, the teacher may initiate the deactivation of the features of the student computing devices from the teacher's computing device. The exchange of signals could be conducted by the system 100 described in FIG. 1, with any suitable wide area network or wireless local area network facilitating the exchange.

In another arrangement, real-time or delayed monitoring of a student's progress in relation to an assignment can be conducted. For example, during a testing time, the teacher can be apprised of each student's progress, including which questions the student has answered correctly or incorrectly. This can be expanded to provide analytics on a cumulative basis for the entire class. Additional material for this concept will be presented below.

As an option, all or at least some of a student's work can be stored, and the student (or some other authorized individual) may access this material. This material can be categorized based on the type of document or the type of subject matter with which it is associated. For example, a student can access and review all his/her documents and work associated with a certain class, like English. This material can also be made available to teachers, administrators, parents and (optionally) other students. Moreover, reference materials or other learning resources can be made available to the student through the computing device. In another arrangement, the student's computing device can be populated with a calendar, which can show impending deadlines for assigned tasks.

To increase interaction among students, teachers, parents and other authorized individuals, a student's computing device can be equipped with multi-media or interactive hardware, like cameras, microphones and speakers and the communication elements needed to enable such interaction. For example, a student can conduct a multi-media conference call with other students through the computing device. As another example, a teacher can record lectures, and the student can access these recordings if the student misses the class. As another option, the student could attend class remotely by watching a live (or delayed) broadcast of the teacher's lecture. Security measures can be put in place, like log in procedures or biometrics, to ensure that only authorized individuals may communicate with students or district employees in this fashion.

Teachers and other school district personnel can also increase the functionality of their trades through the use of a computing device in accordance with the arrangements described herein. In particular, teachers can create assignments or other projects and can cause them to be distributed to the computing devices of their students. These assignments/projects can be developed by the teacher or can be created by school district officials or third parties under the direction of the school district. For example, the school district may have standardized tests created for the students of a particular class and can make this material available in a suitable forum, like the application shop described above. To distribute the tests, a teacher can simply access them from the application shop and cause them to be assigned and disseminated to the appropriate students.

Through access to the application shop, the teacher can choose to distribute any suitable applications and content to her computing device or to those of her students. If desired, all or some of the management features described above can be executed by the teacher, such as the disablement or blacklisting of a particular application or URL.

A teacher can also be given access to information concerning the progress of her students. For example, test scores and other grading can be recorded and packaged for the teacher to enable the teacher to easily see which students require additional help for which subjects. This monitoring process can occur in real-time or upon completion of an assignment. Such information can also be made available to administrators, parents and even students.

Through the computing device, the teacher can also have access to multi-media presentations and can participate in multi-media teleconferencing, including with parents, students and other district employees. As noted earlier, a teacher can also record lectures and make those recordings available to students who may have missed the lectures. Continuing education classes may also be made available to the teacher through the use of the device, via the application shop, for example. In addition, an administrator may also monitor the progress of a teacher's performance, which may be directly or indirectly tied to how well the teacher's students perform. The administrator may also provide feedback to the teacher through this forum. As another option, the teacher can create a lesson plan on her computing device, help for which may be found in the application shop or through some other suitable resources.

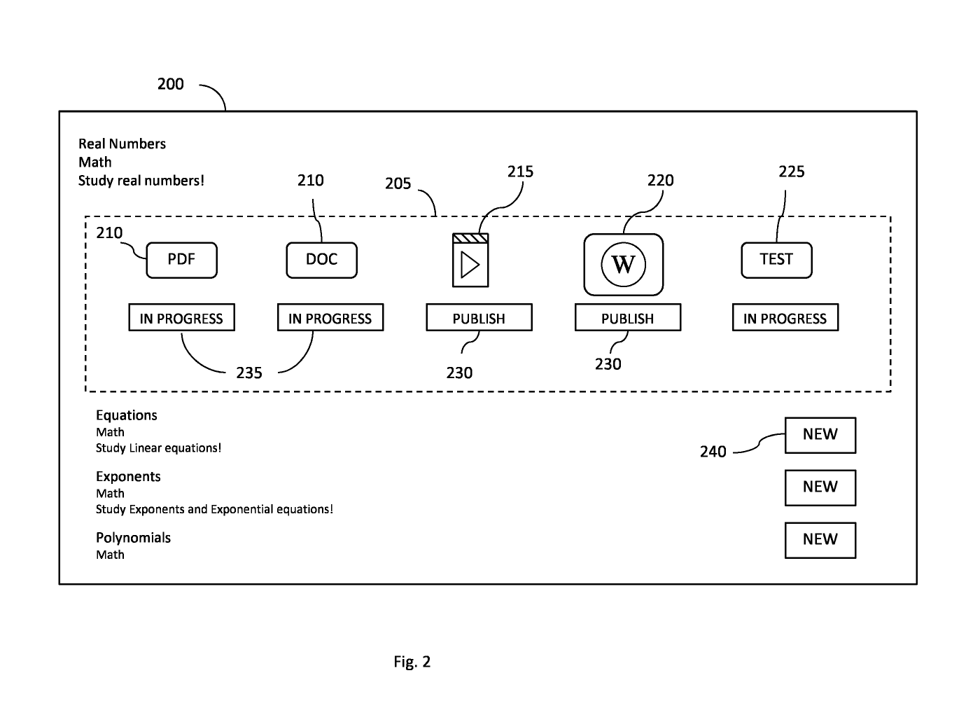

As explained above, a teacher can assign work to her students through her computing device. One particular (non-limiting) example of this process will now be presented. Referring to FIG. 2, an assignments page 200 is presented. The assignments page 200 represents an example of a user interface that can be presented to a teacher on the teacher's computing device to enable the teacher to interact with the teacher's students. Here, for example, a teacher can create a package of materials 205 for the teaching of a particular lesson, and they can be uploaded to the system, such as through the teacher's computing device. These materials can be selected by the teacher from various resources, such as from the application shop. In another arrangement, the school district can prepare (or have prepared) these packages 205 in advance and can make them available in a suitable forum, such as through the application shop. For example, a teacher may wish to teach her class the topic of real numbers in mathematics. The teacher can select the materials from, for example, the application shop or some other platform that is related to this topic. In another arrangement, the school district may have already prepared a package 205 of materials for the teaching of real numbers, and the teacher can simply select this package from the application shop or other forum.

The type of materials in the package 205 is not limited to any particular content. As an example, an electronic document 210 (e.g., pdf or Word document) may be provided that contains a real numbers section from a math textbook, and this section may include a write-up that explains the concept of real numbers and provides sample problems. As another example, the package 205 may include a video 215 or an on-line resource 220 that helps explain the topic of real numbers. The package 205 may also include an examination 225 related to real numbers. Any number of lesson packages and materials may be made available to the teacher and students and displayed on the assignments page 200 of FIG. 2.

In one arrangement, the materials in the package 205 can be designated with a “publish” link 230, and when activated by the teacher or some other suitable entity, the materials can be distributed to the appropriate students. The materials can be disseminated in a piece-meal fashion or can be sent to the student computing devices at roughly the same time. Once a particular element is distributed, the publish link 230 can indicate that the corresponding material has already been disseminated. In this case, the “publish” link 235 can be changed to an “in progress” link 235, which can indicate that the material has already been sent out. A master indicator 240 can also indicate that the package is “new” (not yet distributed) or “in progress” (at least some of the materials have been sent out).

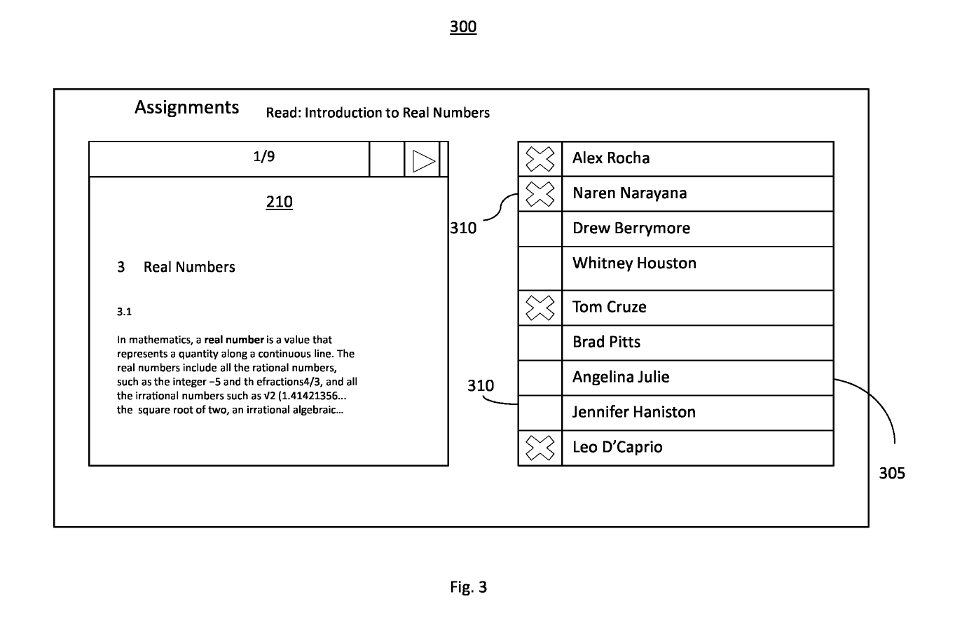

In another arrangement, a teacher or some other party may select one of the materials in the package 205 and can determine additional information related to that particular element. For example, the teacher may select the pdf described above, and the pdf can be opened and the progress of each student with respect to the pdf can be displayed. An example of this is shown in FIG. 3, which illustrates a progress page 300. In one arrangement, the progress page 300 can display the selected electronic document 210 (the pdf, in this example) and an index 305 of participating students.

In this case, the students may be required to read all the pages in the pdf, and their computing devices can report their progress back to the system (and eventually the teacher's device). The index 305 can list each of the students who have been assigned this task and can show through a progress indicator 310 the progress that each student has made for this task. The progress indicator 310 can represent this progress through the use of text, colors or other graphics. This monitoring and reporting can occur in real-time, and as such, the teacher can determine when the task has been completed by all the students. Each of the materials in the package 205 can be accessed and the progress of the students for each of these elements can be tracked and reported back to the teacher, as described above. If one of the materials is a test, the teacher can also be provided with analytics that show the progress of the students in relation to the test. Additional information can also be provided, such as which questions have been answered correctly or incorrectly by each of the students taking the exam. This process can also occur in real-time.

As pointed out earlier, a parent of a student may be given access to the student's computing device and files associated with that device. For example, a separate log-in can be provided for the parent of a student, and the parent can be granted access to various matters associated with the student. In particular, a parent can be permitted to review the student's work documents, monitor the student's academic progress and see which assignments are pending for the student. The academic progress report can include current and past grades and can hi-light areas where the student may need help. Recommendations for resources to help the student can also be made to the parent, particularly materials that are related to those areas that the student is having difficulty mastering. The parent can also be given access to lesson recordings and other educational resources through the computing device, which may be helpful during homework sessions. As another option, the parent may participate in parent-teacher conferences through a multi-media conference call on the student's computing device. Through a similar fashion, a parent can conduct multi-media calls with other parents, and these parents can exchange ideas and other information through any suitable forum. The parent can also be given access to the application shop, where the parent can download applications (including wrapped applications) and other content on behalf of the student.

In one arrangement, the parent may be given the opportunity to obtain a computing device from the school district or some other source, and this device can be provisioned similar to a student's device. This device may be provided by the school district, and the parent may be required to pay an upfront fee and a continuing fee for services. This device can be managed and serviced in accordance with any of the discussion up to this point. In addition, the parent may provide his or her own personal computing device, and it can be provisioned by the school district or some other suitable entity to enable it to operate in accordance with the features and processes described herein.

It is beneficial to configure the computing devices used in this scheme to operate primarily on a low cost or free communication platform, such as Wi-Fi. It is understood, however, that the devices can operate on other wireless or wired protocols, including cellular. In the case of cellular, the parent may be given the opportunity to purchase air minutes for the parent and his/her student. This can ensure continuous operation if a Wi-Fi connection is unavailable.

As previously explained, various profiles can be created for a computing device, such as a personal profile and an educational workspace or secure profile. For example, a student's computing device can include a personal profile and an educational profile. The personal profile can include information, applications, settings and other content that are personal to the student. As a particular example, the personal profile may include an e-mail application that supports a personal account held by the student and can contain a contacts listing of the students friends. Although this information is personal to the student, the school district may still be permitted to at least partially manage this profile. For example, the student may not be permitted to download certain applications or visit some Web sites while the student's personal profile is active on the device, such as during school hours or while on school grounds.

The educational workspace or profile can include information, applications, settings and other content that is related to the education of the student. Examples include the bundles that may be delivered to the student's computing device, the materials that a teacher assigns to the student and the documents and analytics associated with the student's academic progress. This material can include conventional and wrapped applications. For security purposes, the education profile can be isolated from the personal profile, which can ensure the integrity of the content and applications contained in the student's education profile. As such, the applications that are to be distributed as part of the student's education profile can go through the wrapping or securitization process to ensure their isolation from the applications or other programs that make up the student's personal profile. That is, the educational profile can include one or more secure applications. Additionally, the student or other authorized party may be required to enter credentials to gain access to the educational profile on the device.

The creation of different profiles may apply to computing devices that the school district provides or to personal computing devices supplied by students and district employees. In addition, personal profiles and educational or work (i.e., secure) profiles can be created for the personal computing devices of parents, teachers and other school district personnel.

In one arrangement, when a student or district employee enters a school or district building or other designated location, the computing device can deactivate the personal profile and cause the educational or work (secure) profile to be activated. For example, if a student has his personal profile open on the computing device and enters the school, the computing device can be configured to shut down the personal profile and activate the educational profile. Credentials from the student may or may not be required at this step. As an option, once the student leaves school, the computing device can deactivate the educational profile and can enable the personal profile again. The computing device can detect when it has entered school grounds by the identification of the communication resources it is using (e.g., a particular access point), through GPS or other triangulation, through the receipt of a pre-identified beacon or via any other acceptable means of location identification. Time can be a factor in providing access to the profiles, as well. For example, the computing device can be configured to enable a student to access his/her personal profile during lunch hours, following the completion of the school day or during a non-school day. These principles may also apply to applications that have been wrapped, thereby permitting their management.

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

1. A method of selectively deactivating features on a computing device, comprising:
determining an examination time period for one or more students, each of the students in possession of a computing device, wherein the examination time period is set aside to enable the students to participate in a testing exercise;
generating a deactivation signal; and
transmitting the deactivation signal, wherein the deactivation signal, when received at the student computing devices, causes the student computing devices to selectively deactivate predetermined features of the student computing devices, wherein the predetermined features are based on a factor of providing an unfair advantage to a student during the examination time period.

2. The method according to claim 1, further comprising reactivating the deactivated features following the completion of the examination time period.

3. The method according to claim 1, wherein the predetermined features of the student computing devices that are deactivated include applications, access to communications networks and calculators.

4. The method according to claim 1, wherein the deactivation signal is generated by a computing device of an examination proctor.

5. The method according to claim 1, further comprising forcing the student computing devices into a testing mode, wherein the deactivation of the predetermined features is part of the testing mode.

6. The method according to claim 5, wherein another part of the testing mode is automatically silencing the student computing devices to prevent the broadcast of ring tones during the examination time period.

7. A method of preparing a learning package for a group of students, comprising:
retrieving the learning package from a database, wherein the learning package includes predetermined materials that are designed to enable the students to learn a topic;
selecting all or a portion of the materials from the learning package; and
publishing the selected materials to computing devices that are associated with the students, thereby providing an assignment to the students to complete at least a portion of the selected materials.

8. The method according to claim 7, wherein the predetermined materials include reading materials, videos, on-line resources or examinations.

9. The method according to claim 7, wherein the database is associated with an electronic storefront.

10. The method according to claim 9, wherein the electronic storefront is associated with a school district such that the school district determines which materials are to be included in the learning packages and which learning packages are to be offered at the electronic storefront.

11. The method according to claim 7, further comprising reporting the progress of the students in relation to the completion of the assignment.

12. The method according to claim 11, wherein the reporting of the progress of the students may be in terms of the overall completion of the assignment or in terms of the individual components of the assignment.

13. The method according to claim 11, wherein the reporting of the progress of the students is done through a progress indicator assigned to each of the students.

14. The method according to claim 12, wherein the reporting of the progress of the students also provides an indication as to the accuracy of the work of the students for the assignment.

15. A method of modifying an application, comprising:
receiving a non-educational application in its original form;
injecting an educational aspect into the non-educational application, thereby creating a modified application;
wherein when the modified application is launched, the educational aspect interrupts the original flow of the application to direct a user to complete an educational task before the original flow can be resumed.

16. The method according to claim 15, wherein the educational task is one or more questions related to a certain topic, and the original flow is resumed if the user provides correct answers or at least attempts to provide correct answers.

17. The method according to claim 15, wherein the non-educational application is a gaming application.

18. The method according to claim 15, wherein the modified application is intended to be part of an educational profile for a computing device of a student.
